(19) United States
(12) Patent Application Publication
(10) Pub. No.: US 2012/0072995 A1
(43) Pub. Date: Mar. 22, 2012

(54) SYSTEMS AND METHODS FOR MANAGING SOFTWARE LICENSES

(76) Inventor: C.S. LEE CRAWFORD, Irving, TX (US)

(21) Appl. No.: 13/304,675

(22) Filed: Nov. 27, 2011

Related U.S. Application Data
(63) Continuation-in-part of application No. 12/824,165, filed on Jun. 26, 2010.
Application No. 12/824,165 is a continuation-in-part of application No. 11/684,668, filed on Mar. 12, 2007, now abandoned.
Application No. 11/684,668 is a continuation-in-part of application No. 11/424,644, filed on Jun. 16, 2006, now abandoned.
Application No. 11/424,644 is a continuation-in-part of application No. 10/368,311, filed on Feb. 15, 2003, now Pat. No. 7,194,637.
(60) Provisional application No. 60/691,383, filed on Jun. 18, 2005.
(60) Provisional application No. 60/359,549, filed on Feb. 25, 2002.

(51) Int. Cl. G06F 21/22; G06F 15/173

(52) U.S. Cl. 726/26; 709/223

(57) ABSTRACT

In one embodiment, an apparatus for managing software licenses comprises: a plurality of computers connected together in a peer to peer computer network wherein each computer is a computer node of the network; wherein each computer node comprises a software license management controller that operates in one of: a disconnected mode of operation of distributed license management without network connectivity and a normal online mode of operation of distributed license management.

### RELATED APPLICATIONS

This application is a continuation-in-part of U.S. patent application Ser. No. 12/824,165, filed Jun. 26, 2010, which is a continuation-in-part of U.S. patent application Ser. No. 11/684,668 (now abandoned), filed Mar. 12, 2007, which is a continuation-in-part of U.S. patent application Ser. No. 11/424,644 (now abandoned), filed Jun. 16, 2006 (which claims the benefit of U.S. Provisional App. No. 60/691,383, filed Jun. 18, 2005) and is a continuation-in-part of U.S. patent application Ser. No. 10/368,311 (issued as U.S. Pat. No. 7,194,637), filed Feb. 15, 2003 (which, in turn, claims the benefit of U.S. Provisional App. No. 60/359,549 filed Feb. 25, 2002), all of which are incorporated herein by reference.

### BACKGROUND

Software license management is an essential service for any commercial software product to ensure the legitimate usage of the software product and to ensure the proper distribution of the software product. Software license providers (“license providers”) are typically located within software that is located on a computer server. Software license consumers (“license consumers”) are typically software applications that are located on a computer workstation or computer server. Existing software license management systems are based upon the ability of the software provider to communicate securely with the software license consumers.

A license provider has a finite number of software licenses (“licenses”) stored within the computer server on which the license provider is located. The license provider typically has an encrypted license file that contains the names of the licenses and the names of the customers (i.e., license consumers) that are authorized to receive the licenses.

When a license consumer desires to obtain particular software licenses, the license consumer may attempt to acquire the licenses from one or more license providers. The license consumer sends a license request to one or more license providers. A license provider that can satisfy the license consumer's request (1) licenses the requested license (or licenses) to the license consumer, (2) marks the requested license (or licenses) as being in use by the license consumer, and (3) establishes and maintains a secure communication link with the license consumer.

The license provider maintains the secure communication link with the license consumer until the license consumer releases the license (or licenses) or the link with the license consumer fails due to a hardware or software fault, thereby implicitly releasing the license (or licenses). A license that is marked as being in use is not available to other license consumers until the license has been released. Licenses that are released re-enter the available license pool of the license provider.

The encrypted license file in the software license management system may be stored on a disk drive or other memory device such as a Universal Serial Bus (USB) key or smartcard. As previously mentioned, the encrypted license file contains the names of the authorized license consumers and the names of the licenses that they are authorized to receive. The software license management system is capable of reading the authorization information in the encrypted license file and serving the requested licenses to the license consumers that have the proper authorization.

The software license management system typically resides at a location that is remote from the location of the software applications that it licenses. This provides a more convenient centralized administration of the license process. In existing software license management systems, the license provider (located on a license server) is located at a remote location with respect to the license consumer (located on a client server).

Dedicated license servers are not efficient in mobile computing scenarios and are not always optimal for conventional network computing scenarios. For example, dedicated license servers are not efficient at supporting software product demonstrations or training operations at remote non-fixed locations. Prior art approaches to providing software licenses in mobile computing scenarios include providing (for an additional fee) (1) short-term or dedicated entitlement to support mobile use, (2) portable entitlement in the form of hardware keys, (3) temporary offline stand-alone licenses, and (4) node-locked licenses that are not network-based.

The success of Internet protocols and techniques and their application to new classes of software products poses a problem for existing software licensing management systems. This is because systems that are based on Internet protocols and techniques require frequent and ongoing communication between a license provider and a license consumer. Without a continuous assertion of need from a license consumer (1) it is problematic to ensure than the license consumer's entitlement to a software license is genuine and (2) it is problematic to warrant that the license provider's software license pool accurately reflects license availability.

### SUMMARY

In some embodiments, a software licensing architecture is provided in which peer to peer software license management occurs. In the peer to peer software license management, software licenses may be transferred from peer to peer computing platforms without requiring interaction with a central licensing server. Further, the ongoing enforcement of the software licensing occurs in a distributed manner. The distributed license processing may also be implemented to tolerate intermittent network connectivity or disconnected platforms.

In some embodiments, an executive logic layer software module is provided on the peer computing platforms where the executive logic software layer comprises a set of tolerance rules, and a set of service licensing data, a history of network communications, and a user interface module. When a network interrupt occurs, the executive logic layer consults the network communications data to automatically initiate an offline license management mode of operation. When network connectivity is re-established, a second mode of license management is performed using suitable network communications.

The foregoing has outlined rather broadly certain features and/or technical advantages in order that the detailed description that follows may be better understood. Additional features and/or advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the appended claims.

### BRIEF DESCRIPTION OF THE DRAWINGS

FIG. 1 depicts a computer node with a software license daemon for operation in a peer to peer network according to one representative embodiment.

FIG. 2 depicts two computer nodes with respective communicating software license daemons according to one representative embodiment.

FIG. 3 depicts a flowchart for conducting license management operations in a peer to peer network according to one representative embodiment.

### DETAILED DESCRIPTION

Every computer that participates in the peer to peer software license management system is referred to as a node. In a peer to peer system, each node can accept incoming connections from other nodes and each node can initiate outgoing connections to other nodes. This feature distinguishes a peer to peer system from a conventional client-server system. In a conventional client-server system, only client nodes can initiate outgoing connections and only server nodes can accept incoming connections.

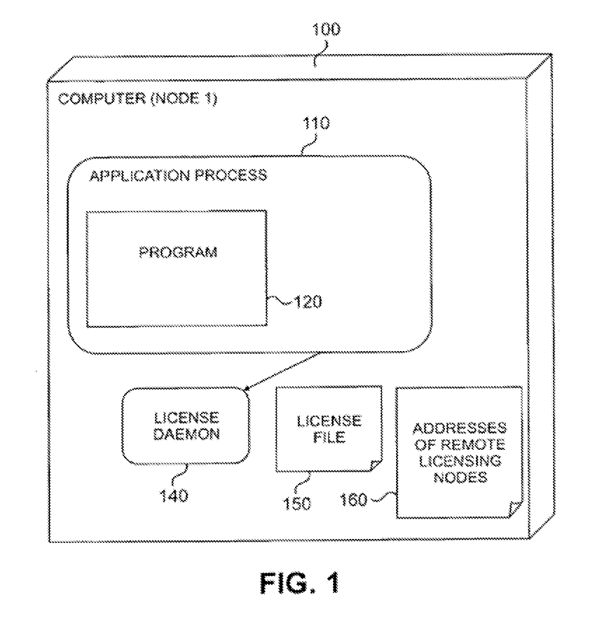

FIG. 1 illustrates a schematic representation of an exemplary first computer node 100 (also designated as node 1) of the peer to peer software license management system. First computer node 100 is representative of each of the other nodes in the system (not shown in FIG. 1). As shown in FIG. 1, first computer node 100 comprises an application process 110. Application process 110 may include functionality within its code to condition execution of all or selected program functionality according to the license data and licensing terms defined for application process 110. In other embodiments, a separate executive or rights management process or processes, or other software functionality (not shown) performs the license enforcement, e.g. an operating system digital rights management software suite. First computer node 100 also comprises a continuously, scheduled, or intermittently executed program that is referred to license daemon 140.

First computer node 100 also comprises an encrypted license file 150. The encrypted license file 150 contains the names of authorized license consumers, the names of the software licenses that they are authorized to receive, and/or any other suitable license management data. A number of different license schemes may be employed according to representative embodiments. The specific licensing scheme selected for a given software product may affect the data stored in license file 150. In some embodiments, software is licensed to a specific organization. According to the licensing terms, the organization may select a given number of end-users that may access the software at any given time. Within this scheme, the organization may register users, de-register some users, and register other replacement end-users as deemed appropriate by the organization subject to the total end-user license limit. Upon registration or de-registration (or similar operations), remote license data may be uploaded to a server of a software organization responsible for the licensed software and/or local license data may be updated to reflect the change in licensing state of a particular end-user and/or computer node. In some embodiments, data corresponding to these various operations are maintained in encrypted license file 150.

The license daemon 140 is connected to and in communication with the encrypted license file 150. The license daemon 140 is capable of reading the information in the encrypted license file 150 to manage, enforce, and/or otherwise facilitate license authorization operations. License daemon 140 is adapted to communicate data in its local license file 150 with license daemons located on other computing platforms. Further, license daemon 140 is further adapted to receive license data from other license daemons located on other computing platforms. Various data structures may be employed to manage and control the software license operations on a given computer node. For example, software use, software installation, software license transfer, and other software operations conditioned on the license status of a given end-user or computer node may occur in relation to various date stamped metadata reflecting the various license states. The license states may include any suitable license states such as specific end-user and/or computer node license data, check-out license operations, check-in license operations, and/or the like.

First computer node 100 also comprises an address file 160 that contains computer addresses of other nodes (e.g., remotely located) where distributed license data is located (e.g., other peer licensing nodes in the peer to peer system). The license daemon 140 is connected to and in communication with the address file 160. The license daemon 140 is also capable of communicating with the other nodes in the peer to peer system. In other embodiments, license daemon 140 is capable of automatically communicating with other such nodes, intermittently, permanently, or semi-permanently. License daemon 140 may also automatically traverse through addresses on a local area network or addresses within a small wireless network to “discover” or identify other nodes that include other license daemons, etc. to communicate license data with such other license daemons. In such embodiments, license data may be cascaded or communicated along a chain of license daemons on multiple separate computing platforms to ultimately arrive at license daemon 140.

The standard computer hardware of computer node 100 (central processing unit, memory units, etc.) and the standard computer software of computer node 100 (operating system, etc.) together with the software and/or stored data of one peer to peer software license management system (license daemon, license file, licensing library, etc.) comprises a software license management controller that performs the functions of the some embodiments of the present invention.

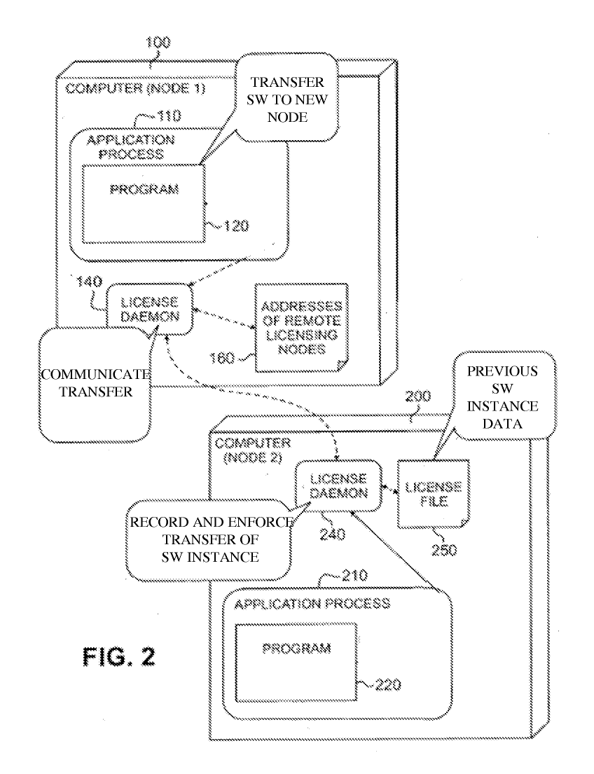

FIG. 2 illustrates a schematic representation of the first computer node 100 of executing a program according to an instance of a software license in conjunction with communication with a second computer node 200 of the peer to peer license management system. Second computer node 200 comprises an application process 210 that comprises at least one program 220. Second computer node 200 also comprises its own license daemon 240 and encrypted license file 250. Although not shown in FIG. 2, the second computer node 200 also comprises an address file that contains computer addresses of other nodes in the license management system.

FIG. 2 illustrates how the first computer node 100 may access a software license data from the second computer node 200 in the peer to peer system. When the at least one program 120 requires a license evaluation operation, local license evaluation operations are performed. In such operations, the license daemon 140 attempts to access the license data from its own encrypted license file 150 (not shown in FIG. 2). Access to the licensed software is then controlled in accordance with the license data.

At appropriate times (e.g., upon installation of an instance of software, subsequent use, or other times), the license daemon 140 communicates with the remote nodes. FIG. 2 illustrates the connection and communication between license daemon 140 of the first computer node 100 and the license daemon 240 of the second computer node 200.

In some embodiments, the software of the various computer nodes (including nodes 100 and 200) are adapted to perform distributed enforcement of software licenses, i.e. the execution of software instances on different nodes is conditioned upon compliance with the licensing terms of the software program or package. In some embodiments, the peer to peer communication is employed to perform the distributed enforcement. For example, suppose a specific end-user wishes to obtain use of the software in accordance with the defined licensing terms. The addition of the specific end-user must bring the end-user total to a number that is less than or equal to the license limit. Assuming that this is the case, this end-user should be given access generally irrespective of the originating computer node of the license operation/evaluation. Otherwise when the addition would cause an over-limit condition, the end-user should be denied access generally irrespective of the originating computer node of the license operation/evaluation. Similarly, an end-user may legitmately attempt to move execution to a new computer node from another computer node subject to the software license terms.

To facilitate such distributed enforcement, license daemons 140 and 240 may communicate their own licensing data between each other. Also, license daemons may communicate licensing data received from other license daemons of other nodes. By “cascading” or otherwise distributing licensing data throughout the peer to peer network, the various license daemons (including daemons 140 and 240) are able to facilitate license operations on a specific node that is consistent with the licensing terms intended for multiple computer nodes and end-users. Specifically, by communicating in this manner, it is possible to condition execution of a specific instance of software licensed for a multiplicity of end-users upon compliance with the licensing terms without engaging a central server to manage, control, and direct licensing operations.

Further, some embodiments adapt to intermittent network connectivity of various computer nodes. For example, mobile devices may possess wireless network communication capabilities. In certain locations, those mobile devices may be able to communicate through a wireless network. In other locations, no wireless network signal may be received by the respective mobile device and, hence, such a mobile device would be temporarily “offline.” Some embodiments adapt to such offline status by locally storing the distributed license data on the various nodes of the peer to peer network. If a particular node becomes disconnected or offline, the license data specific to the offline computer node is still available elsewhere in the peer to peer network. Thereby, licensing operations may continue to occur without regard to the offline status of that computer node.

In some embodiments, the peer to peer license management system comprises a plurality of computers connected and each computer is a computer node of the network. Each computer node comprises a software license management controller that operates in one of: a disconnected mode of operation of distributed license management without network connectivity and a normal online mode of operation of distributed license management.

In some embodiments, the software license management controller stores data related to prior successful or unsuccessful network communications in association with license management data. Such data may be employed to control license data communication and/or license operations.

In other embodiments, a degree of fault tolerance is employed in the license enforcement. Network connectivity issues and otherwise “offline” devices may complicate license evaluation, transfer, enforcement, etc. In some embodiments, a degree of fault tolerance is employed. For example, the license management software may be adapted to apply certain permissive defaults until certain computing platforms are available in the peer to peer network. In one embodiment, the license management software may assume, e.g., for a limited period of time, that software has been removed or de-licensed from an end-user or a specific mobile device (subject to certain limitations and conditions) even without explicit instananeous verification of such removal or de-licensing. Accordingly, e.g., for a brief period of time, the network unavailability will not prevent provision of a software license for another end-user. When the respective mobile or other previously offline device does re-establish network connectivity, the various license daemons will coordinate and reconcile their various license data and appropriate licensing operations will occur (e.g., one of the end-user's rights may be revoked if there is an over-limit condition with the total number of end-users).

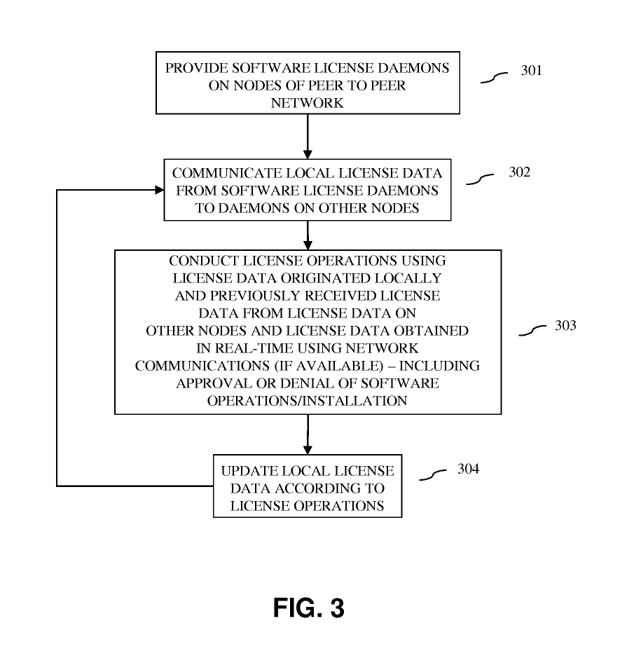

FIG. 3 depicts a flowchart for conducting license operations in a peer to peer network according to one representative embodiment. In 301, software license daemons are provided on nodes of peer to peer network. In 302, local license data is communicated from software license daemons to daemons on other nodes in the peer to peer network. Data cascading (e.g., forwarding of license data from an originating node through one or more intermediate nodes) may occur. In 303, license operations are conducted using license data originated locally and previously received license data from license data on other nodes and license data obtained in real-time using network communications (if available). The license operations may include approval or denial of software operations, transfer, installation, and/or the like. The license operations occur in a distributed manner. That is, selected nodes performs a local license operation evaluation. The local license operation evaluation may involve consideration of license operations that have occured on other nodes (e.g., evaluation of whether a license limit has been reached). In 304, local license data is updated according to the performed license operations. From 304, the process flow returns to 302 to update the license data across the peer to peer network to conduct license operations according to the updated data.

It may be advantageous to set forth definitions of certain words and phrases used throughout this patent document. The terms “application,” “program,” and “routine” refer to one or more computer programs, sets of instructions, procedures, functions, objects, classes, instances, or related data adapted for implementation in a suitable computer language. The term “couple” and its derivatives refer to any direct or indirect communication between two or more elements, whether or not those elements are in physical contact with one another.

The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

Although certain representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate when reading the present application, other processes, machines, manufacture, compositions of matter, means, methods, or steps, presently existing or later to be developed that perform substantially the same function or achieve substantially the same result as the described embodiments may be utilized. Accordingly, the appended claims are intended to include within their scope such processes, machines, manufacture, compositions of matter, means, methods, or steps.

1. An apparatus for managing software licenses comprising:
a plurality of computers connected together in a peer to peer computer network wherein each computer is a computer node of the network; wherein each computer node comprises a software license management controller that operates in one of: a disconnected mode of operation of distributed license management without network connectivity and a normal online mode of operation of distributed license management.

2. The apparatus of claim 1 wherein at least one of the computer modes comprises wireless connectivity that permits intermittent wireless network communication.

3. The apparatus of claim 1 wherein the software license management controller stores a data related to prior network communications in association with license management data.

4. An apparatus for managing software licenses comprising:
a plurality of computers connected together in a peer to peer computer network wherein each computer is a computer node of the network, wherein: (i) each computer node comprises a software license management controller; (ii) a plurality of the software license management controllers of the peer to peer computer network store license management data specific for its own computer node and license management data specific for other computer nodes in the peer to peer computer network; (iii) the software license management controllers are operable to conduct communications with each other to perform distributed license management and enforcement of licensed software that is licensed for a plurality of end-users

5. The apparatus of claim 4 wherein each software license management controller accesses a local file that includes addresses of other computer nodes where license management data may be obtained.

6. The apparatus of claim 5 wherein the local file is an encrypted file.

7. The apparatus of claim 4 wherein each software license management controller automatically traverses selected network addresses to identify other software license management controllers in the peer to peer network.

8. The apparatus of claim 4 wherein the software license management controllers are operate to coordinate to enforce license restrictions when some of the computer nodes go offline.

9. The apparatus of claim 8 wherein at least some of the computer nodes have intermittent network connectivity.

10. The apparatus of claim 9 wherein at least some of the computer nodes comprise wireless network communication capabilities.
